(19) United States
(12) Patent Application Publication
(10) Pub. No.: US 2026/0183751 A1
(43) Pub. Date: Jul. 2, 2026

(54) CATALYST SYSTEM FOR A FLOW REACTOR, AND METHOD FOR THE CATALYTIC OXIDATION OF AMMONIA

(71) Applicant: HERAEUS PRECIOUS METALS GMBH & CO. KG, Hanau (DE)

(72) Inventors: Jens HESSE, Hanau (DE); Pascal HIRSCHEL, Hanau (DE); Dirk MAIER, Hanau (DE); Uwe JANTSCH, Hanau (DE)

(21) Appl. No.: 18/868,517

(22) PCT Filed: Feb. 24, 2023
(86) PCT No.: PCT/EP2023/054653

§ 371 Date: Nov. 22, 2024

(30) Foreign Application Priority Data
May 25, 2022 (EP) 22175273.6

(51) Int. Cl. B01J 23/56; B01J 35/58; C01B 21/087; C01B 21/38

(52) U.S. Cl. CPC B01J 23/56; B01J 35/58; C01B 21/087; C01B 21/38

(57) ABSTRACT

The invention relates to a catalyst system for flow reactors, said catalyst system being characterized by the order of the noble metal-containing alloys used in the catalyst gauze which forms the catalyst system. By using a ternary platinum alloy for a second catalyst gauze group and a palladium alloy for a third catalyst gauze group, the platinum and rhodium content of the catalyst system can be kept relatively low overall while having a high degree of efficiency. The invention additionally relates to a method for catalytically combusting ammonia, in which a fresh gas which contains at least ammonia is conducted through a catalyst system.

The present invention relates to a catalyst system for flow reactors which is characterized by the sequence of the noble metal-containing alloys used in the catalyst gauzes forming the catalyst system. In addition, the invention relates to a method for catalytic combustion of ammonia, in which a fresh gas containing at least ammonia is conducted through a catalyst system.

Catalyst systems in the sense of the present invention are used in particular for gas reactions. They are used, for example, in the preparation of hydrocyanic acid by the Andrussow process or in the preparation of nitric acid by the Ostwald process. In order to provide a large catalytically active surface for these reactions, such catalysts generally comprise a spatial, gas-permeable structure. Collecting systems for recovering evaporated catalytically active components are also frequently based on such lattice structures. Usually, a plurality of gauzes are expediently arranged one behind the other and combined to form a catalyst system. The catalyst gauzes usually consist of single-layer or multi-layer knitted fabrics, braided fabrics, or woven fabrics. The individual gauzes consist of fine noble metal wires which predominantly contain platinum (Pt), palladium (Pd), rhodium (Rh) or alloys of these metals. In particular, collecting gauzes may also contain further constituents, for example nickel.

Depending on the design, systems comprising 2 to 50 catalyst gauzes with a diameter of up to 6 m are used in flow reactors. The use of noble metal represents a high, committed investment and is kept as low as possible. On the other hand, the “catalytic efficiency,” which is an important parameter and a measure of continuously high conversions of the reactants and good yield, depends on the noble metal content. Due to increasing noble metal prices and the resulting capital investment tied up in the catalyst systems, the aim is to minimize the noble metal content of the catalyst systems while maintaining efficiency.

During operation, the catalyst gauzes continuously lose noble metal due to oxidation and sublimation, and therefore they have to be replaced from time to time (endurance, service life) with a certain outlay. The PtRh5 alloy, which has become established as an industrial standard for noble metal catalysts for use in medium-pressure systems, has proven to be a suitable compromise with regard to service life, catalytic efficiency and noble metal use.

EP 3680015 A1 discloses catalyst systems composed of at least two gauze layers, in which preferably binary PtRh alloys with a rhodium content decreasing in the flow direction are used. The overall platinum and rhodium content of the catalyst systems is high due to the use of binary platinum-rhodium alloys.

In order to reduce the noble metal use while maintaining the catalytic efficiency, EP 1284927 A1 proposes a catalyst system composed of at least two gauze layers, in which the first gauze, as seen in the flow direction, is formed from a platinum rhodium alloy and the second gauze is formed from a palladium rhodium alloy.

CN 101554585 A describes a catalyst system comprising at least three gauze layers made of alloys having different compositions. The first and second gauze layers are made of a platinum alloy, with the platinum alloy of the middle gauze layer containing a lower platinum content.

The object of the present invention was to provide a catalyst system for a flow reactor in which the use of platinum and rhodium can be reduced by using higher proportions of palladium without having to accept losses in catalytic efficiency.

In addition, the object of the invention was to specify a method for the use of such a catalyst system.

The object is achieved by a catalyst system for a flow reactor, comprising at least three catalyst gauze groups arranged one behind the other in the flow direction, each catalyst gauze group being formed from at least one catalyst gauze composed of at least one noble metal wire in each case, and
the first catalyst gauze group comprising at least one catalyst gauze composed of at least one first noble metal wire made of a platinum alloy, the platinum alloy of the first noble metal wire consisting of, in addition to impurities, 80-98 wt. % platinum, 2-20 wt. % rhodium, and 0-15 wt. % palladium,
the second catalyst gauze group comprising at least one catalyst gauze composed of at least one second noble metal wire made of a platinum alloy, the platinum alloy of the second noble metal wire consisting of, in addition to impurities, 75-98 wt. % platinum, 1-16 wt. % rhodium, and 1-20 wt. % palladium, and
the third catalyst gauze group comprising at least one catalyst gauze composed of at least one third noble metal wire made of a palladium alloy, the palladium alloy of the third noble metal wire consisting of, in addition to impurities, 70-97 wt. % palladium, 0-10 wt. % rhodium, and 3-30 wt. % of at least one further metal, the at least one further metal being selected from the group consisting of nickel, tungsten, platinum and gold,
   characterized in that the rhodium content of the noble metal wires of the catalyst gauze groups decreases or remains constant in the flow direction and in that the palladium content of the noble metal wires of the catalyst gauze groups increases in the flow direction.

Within the scope of the invention, it has been found that, surprisingly, the positioning of catalyst gauzes with different compositions in the rear region of the catalyst system as seen in the flow direction has a significant influence on the efficiency of the system. By using a ternary platinum alloy for the second catalyst gauze group and a palladium alloy for the third catalyst gauze group, the platinum and rhodium content of the catalyst system can be kept relatively low overall while achieving high efficiency. Such systems offer economic advantages, especially in view of the prospect of lower palladium prices.

The present invention relates to a catalyst system for a flow reactor. In flow reactors, catalysts in the form of gas-permeable fabrics are typically incorporated into the reaction zone in a plane perpendicular to the flow direction of the fresh gas. Such gas-permeable fabrics are usually employed in the form of catalyst gauzes. A catalyst system is understood to mean an assembly of such catalyst gauzes.

The catalyst system according to the present invention comprises at least three catalyst gauze groups arranged one behind the other in the flow direction. Each catalyst gauze group is formed from at least one catalyst gauze composed of at least one noble metal wire in each case. A catalyst gauze group is understood to mean an assembly of at least one catalyst gauze in which the composition of the noble metal wires does not differ. Typically, a catalyst gauze group comprises more than one catalyst gauze. A catalyst system according to the invention thus comprises at least three catalyst gauzes composed of noble metal wires having three different compositions.

In the flow direction, the reacting gases first pass through the first, then the second and finally the third catalyst gauze group.

A catalyst gauze is understood to mean a single-layer or multi-layer gas-permeable fabric. The surface formation of the catalyst gauzes can be achieved by interlocking one or more noble metal wires to form a mesh. Catalyst gauzes can be produced, for example, by weaving, braiding or knitting a noble metal wire or a plurality of noble metal wires. The structure of the catalyst gauzes can thereby be set in a targeted manner by the use of different weaving, braiding or knitting patterns and/or different mesh sizes.

The catalyst gauze or catalyst gauzes of the first catalyst gauze group, the catalyst gauze or catalyst gauzes of the second catalyst gauze group and the catalyst gauze or catalyst gauzes of the third catalyst gauze group can be braided, woven and/or knitted independently of one another. Thus, braided, woven and knitted catalyst gauzes can be combined with one another as desired. For example, the catalyst gauze or catalyst gauzes of the first catalyst gauze group may be braided and the catalyst gauze or catalyst gauzes of the second and the third catalyst gauze group may be knitted. Likewise, the catalyst gauze or catalyst gauzes of the first catalyst gauze group may be knitted, the catalyst gauze or catalyst gauzes of the second knitted, and the catalyst gauze or catalyst gauzes of the third catalyst gauze group woven.

The catalyst gauze or catalyst gauzes of the first catalyst gauze group comprise a first weaving, braiding or knitting pattern and a first mesh size. The catalyst gauze or catalyst gauzes of the second catalyst gauze group comprise a second weaving, braiding or knitting pattern and a second mesh size, and the catalyst gauze or catalyst gauzes of the third catalyst gauze group comprise a third weaving, braiding or knitting pattern and a third mesh size.

It has proven advantageous if at least two of the first, second and third weaving, braiding or knitting patterns are the same; particularly advantageously, the first, second and third weaving, braiding or knitting patterns are all the same.

Furthermore, it can be advantageous if at least two of the first, second and third mesh sizes are the same; particularly advantageously, the first, second and third mesh sizes are all the same.

The mass per unit area of the catalyst gauzes is not further limited. The mass per unit area of the catalyst gauzes can be in the range of 100 to 950 g/m², in particular in the range of 150 to 800 g/m². The masses per unit area of the catalyst gauzes within one of the at least three catalyst gauze groups can be the same or different. It has proven advantageous if the catalyst gauzes of a catalyst gauze group have the same mass per unit area.

The masses per unit area of the catalyst gauzes of the at least three catalyst gauze groups can remain equal, decrease or increase in the flow direction.

In preferred embodiments, at least one of the catalyst gauzes can comprise a three-dimensional structure. In the context of this application, gauzes are understood as flat, two-dimensional objects. A three-dimensional structure is understood to mean that the catalyst gauze also comprises, in addition to its planar extension, an extension into the third spatial dimension. Catalyst gauzes having a three-dimensional structure comprise a larger surface area, which advantageously affects the catalytic effectiveness and can reduce the pressure drop in the flow reactor. A three-dimensional structure can be obtained by using at least one noble metal wire having a two- or three-dimensional structure or by texturing the catalyst gauze. Three-dimensional structures of the catalyst gauze may be, for example, wave-shaped or coil-shaped. To produce such structures, an initially planar catalyst gauze may be subjected to a process step in which a three-dimensional structure is embossed or produced by folding.

Three-dimensional structures may be obtained by placing a planar catalyst gauze on a rigid, permeable, but non-planar surface, for example a preformed metal gauze. The structure of such a textured, permeable surface, which does not have to be catalytically effective, is then transferred to the catalyst gauze. Catalyst gauzes having such structures are also referred to as corrugated.

It has proven advantageous if at least one catalyst gauze of the catalyst system according to the invention comprises a three-dimensional structure, in particular if the catalyst gauze is a corrugated catalyst gauze. It may be advantageous if at least one catalyst gauze of each catalyst gauze group comprises a three-dimensional structure.

The number of catalyst gauzes used depends on the conditions in which the flow reactor is operated. Among other things, the throughput of fresh gas, which depends inter alia on the pressure, is a critical factor. For example, in a flow reactor operated at low pressure, e.g. up to approximately 5 bar abs., typically less than 15, often between 5 and 10 catalyst gauzes may be used, while at higher pressure, e.g. up to 15 bar, a larger number of catalyst gauzes, typically more than 20, often between 30 and 50, may be used.

The catalyst gauzes are formed from at least one noble metal wire in each case. The noble metal is preferably selected from the group consisting of the platinum metals, gold and silver. Platinum metals are understood to mean the metals of the so-called platinum group, i.e., platinum (Pt), palladium (Pd), iridium (Ir), rhodium (Rh), osmium (Os) and ruthenium (Ru). A noble metal wire is understood to be a wire consisting of noble metal or a noble metal alloy.

Preferably, noble metal wires are used that have a diameter of 40-250 μm, preferably 50-200 μm, particularly preferably 60-150 μm.

The noble metal wires can be designed as round wire, i.e., with a round cross section. In another embodiment, at least one of the noble metal wires can be designed as a flattened round wire or as a wire with a different cross section.

The noble metal wires may comprise a plurality of wires, in this case also referred to as filaments. The filaments can all consist of the same material, i.e., all containing noble metal, or consist of different materials, which in turn do not have to all contain noble metal.

The filaments may be twisted together; in these cases the noble metal wires comprise a rope-like structure.

The noble metal wires may comprise one or more helically formed longitudinal sections or may be formed over the entire length as a helically curved wire. If a noble metal wire comprises a helically formed longitudinal section, both the active catalyst surface of a catalyst gauze and the mass of the catalyst gauze relative to a surface unit may be adjusted, for example, via the wire thickness or via the number of turns of the helical longitudinal section. When such noble metal wires are used, the catalyst gauze produced therefrom can comprise a three-dimensional structure.

In many cases, it may be advantageous if a catalyst gauze is formed from two or more noble metal wires. In these cases, the noble metal wires may consist of the same material or of different materials. The plurality of noble metal wires may comprise the same or different diameters.

The first catalyst gauze group of the catalyst system according to the invention comprises at least one catalyst gauze composed of at least one first noble metal wire. The first noble metal wire comprises a platinum alloy which consists of, in addition to impurities, 80-98 wt. % platinum, 2-20 wt. % rhodium and 0-15 wt. % palladium.

A platinum alloy is understood to mean an alloy which consists of platinum to an extent of more than 50 wt. %. The fact that the alloy consists of 80-98 wt. % platinum means that the weight proportion of platinum makes up 80-98 wt. % of the weight of the total alloy. The platinum alloy of the first noble metal wire preferably contains 85-97 wt. % platinum, in particular 90-95 wt. %.

The noble metal alloys described herein may contain impurities. In the present case, an impurity is understood to mean an intended or unavoidable impurity caused by the production of the alloy or the alloys. Unless stated otherwise, the proportion of impurities in total is no more than 1 wt. % for all the noble metal alloys described, based on the total weight of the particular noble metal alloy, preferably no more than 0.5 wt. %. The noble metal alloys of the present application comprise in particular the platinum alloys of the first and second noble metal wires and the palladium alloy of the third noble metal wire.

In preferred embodiments, the platinum alloy of the first noble metal wire contains 3-18 wt. % rhodium, in particular 5-15 wt. %.

The platinum alloy of the first noble metal wire preferably contains no more than 15 wt. % palladium, in particular no more than 10 wt. %, particularly preferably no more than 5 wt. %.

The first noble metal wire can comprise a ternary platinum alloy consisting of platinum, rhodium and palladium. The ternary platinum alloy may also contain impurities as described above. In such cases, the platinum alloy of the first noble metal wire is, for example, PtRh5Pd5 or PtRh5Pd15. PtRh(X)Pd(Y) here means that the alloy contains X wt. % rhodium and Y wt. % palladium and, apart from impurities, consists of (100−(X+Y)) wt. % platinum.

Particularly preferably, the first noble metal wire comprises a binary platinum alloy consisting of platinum and rhodium. The binary platinum alloy may also contain impurities as described above. In such cases, the platinum alloy of the first noble metal wire is, for example, PtRh3, PtRh5, PtRh8, PtRh10 or PtRh15. PtRh(X) here means that the alloy contains X wt. % rhodium and, apart from impurities, consists of (100−X) wt. % platinum.

In preferred embodiments, the first catalyst gauze group comprises 1 to 10 catalyst gauzes, preferably 3 to 8 catalyst gauzes. In particular, the first catalyst gauze group may comprise 1, 2, 3, 4, 5, 6, 7, 8, 9 or 10 catalyst gauzes.

Surprisingly, it has been found that it is sufficient for an adequate catalytic efficiency if the first catalyst gauze group comprises only one catalyst gauze. This represents a particularly simple and therefore preferred embodiment of the catalyst system.

The second catalyst gauze group of the catalyst system according to the invention comprises at least one catalyst gauze composed of at least one second noble metal wire composed of a platinum alloy. The platinum alloy of the second noble metal wire consists of, in addition to impurities, 75-98 wt. % platinum, 1-16 wt. % rhodium and 1-20 wt. % palladium.

The platinum alloy of the second noble metal wire preferably contains 80-95 wt. % platinum, in particular 85-90 wt. %.

In preferred embodiments, the platinum alloy of the second noble metal wire contains 2-15 wt. % rhodium, in particular 5-12 wt. %.

The platinum alloy of the second noble metal wire preferably contains more than 1 wt. % palladium, in particular more than 5 wt. %, particularly preferably more than 10 wt. %.

The platinum alloy of the second noble metal wire is a ternary platinum alloy and may contain impurities in addition to platinum, rhodium and palladium. The proportion of impurities in total is no more than 1 wt. % of the platinum alloy, preferably no more than 0.5 wt. %.

The platinum alloy of the second noble metal wire may be, for example, PtRh5Pd5, PtRh1.5Pd13, PtRh2.5Pd17, PtRh4Pd14 or PtRh3.5Pd16. PtRh(X)Pd(Y) here means that the alloy contains X wt. % rhodium and Y wt. % palladium and, apart from impurities, consists of (100−(X+Y)) wt. % platinum.

In preferred embodiments, the second catalyst gauze group comprises 1 to 10 catalyst gauzes, preferably 3 to 8. In particular, the second catalyst gauze group may comprise 1, 2, 3, 4, 5, 6, 7, 8, 9 or 10 catalyst gauzes. The second catalyst gauze group preferably comprises more catalyst gauzes than the first catalyst gauze group.

The third catalyst gauze group of the catalyst system according to the invention comprises at least one catalyst gauze composed of at least one third noble metal wire made of a palladium alloy.

In addition to impurities, the palladium alloy of the third noble metal wire consists of 70-97 wt. % palladium, 0-10 wt. % rhodium and 3-30 wt. % of at least one further metal, wherein the at least one further metal is selected from the group consisting of nickel, tungsten, platinum and gold.

A palladium alloy is understood to mean an alloy that consists of palladium to an extent of more than 50 wt. %. The palladium alloy of the third noble metal wire preferably comprises a palladium content in the range of 75-96 wt. %, preferably of 80-95 wt. %.

The palladium alloy of the third noble metal wire preferably contains the at least one further metal in the range of 4-25 wt. %, particularly preferably in the range of 5-20 wt. %.

The palladium alloy of the third noble metal wire may contain any combination from the group consisting of nickel, tungsten, platinum and gold.

The palladium alloy of the third noble metal wire may contain impurities in addition to palladium, nickel, tungsten, platinum or gold and optionally rhodium. The third noble metal wire may comprise a ternary palladium alloy consisting of palladium, platinum and rhodium in addition to impurities or a binary palladium alloy that contains palladium and nickel, tungsten, platinum or gold in addition to impurities. The proportion of impurities in total is no more than 1 wt. % of the palladium alloy of the third noble metal wire, preferably no more than 0.5 wt. %.

In preferred embodiments, the palladium alloy of the third noble metal wire comprises a rhodium content of 1-10 wt. %, in particular in the range of 3-8 wt. %. With regard to high catalytic efficiency with simultaneously low or no negative effects on service life, it may be advantageous for the palladium alloy of the third noble metal wire to contain at least 1 wt. % rhodium. In such cases, the third noble metal wire particularly preferably comprises a platinum content of at least 1.5 wt. %.

The palladium alloy of the third noble metal wire can be, for example, PdPt10Rh5, PdPt5Rh5, PdPt15Rh3 or PdPt20Rh1. PdPt(Z)Rh(X) herein means that the alloy contains Z wt. % platinum and X wt. % rhodium and, apart from impurities, consists of (100−(Z+X)) wt. % palladium.

According to the invention, the rhodium content of the noble metal wires of the catalyst gauze groups decreases or remains the same. Catalyst systems with such a rhodium gradient have surprisingly been found to be more efficient than systems in which one or more catalyst gauzes comprising a noble metal wire made of an alloy having a higher rhodium content are arranged in the rear or rearmost region of the catalyst system.

In preferred embodiments, the rhodium content of the third noble metal wire is below the rhodium content of the second noble metal wire by at least 2 weight percentage points, particularly preferably by at least 3 weight percentage points.

It may be preferred that the third noble metal wire does not contain rhodium. In these cases, the palladium alloy of the third noble metal wire is preferably a binary palladium alloy, i.e. it consists of, in addition to palladium and impurities, only one further component. The further component is preferably platinum or nickel.

According to the invention, the palladium content of the noble metal wires of the catalyst gauze groups increases in the flow direction. Surprisingly, it has been found that a catalyst system with an increasing palladium gradient in the configuration according to the invention has high catalytic efficiency despite the associated reduction in platinum and rhodium.

It may be advantageous if the third noble metal wire is platinum-free. In such embodiments, the platinum content in the catalyst system may be further reduced. Particularly preferably, in such cases, the third noble metal wire comprises a binary palladium alloy consisting of palladium, impurities and nickel, tungsten or gold.

Examples of a preferred binary palladium alloy of the third noble metal wire include PdNi5, PdW5, PdPt5, PdAu5, PdNi3, PdW3 and PdAu3. PdPt(Z) means that the alloy contains Z wt. % platinum and, apart from impurities, consists of (100−Z) wt. % palladium.

In preferred embodiments, the third catalyst gauze group comprises 1 to 10 catalyst gauzes, preferably 2 to 8. In particular, the third catalyst gauze group may comprise 1, 2, 3, 4, 5, 6, 7, 8, 9 or 10 catalyst gauzes. The third catalyst gauze group preferably comprises more catalyst gauzes than the first or second catalyst gauze group.

In general, the largest proportion of the total volume of the catalyst system of, for example, at least 70% is accounted for by the catalyst gauzes of the second and third catalyst groups, and it is sufficient if only a small volume proportion of, for example, less than 30%, preferably less than 25%, and particularly preferably less than 20% is accounted for by catalyst gauzes of the first catalyst gauze group composed of the noble metal wire richest in rhodium. The volume of the catalyst system or of the catalyst gauze groups is determined primarily by the number of catalyst gauzes used in each case.

In preferred embodiments of the catalyst system according to the invention,
the first noble metal wire is made of a binary platinum alloy consisting of platinum and rhodium,
the second noble metal wire is made of a ternary platinum alloy consisting of platinum, rhodium and palladium, and
the third noble metal wire is made of a binary palladium alloy consisting of palladium and nickel, tungsten, platinum or gold.

In particular, the first noble metal wire may consist of a PtRh(2-10) alloy, the second noble metal wire of a PtRh(1-16)Pd(1-20) alloy, and the third noble metal wire of a PdNi(3-30) alloy, a PdW(3-30) alloy, a PdPt(3-30) alloy, or a PdAu(3-30) alloy. PtRh(a-b) here means, for example, that the alloy contains rhodium with a weight proportion in the range from a to b wt. %, and the remaining proportion of the (100−(a to b)) wt. %, apart from impurities, consists of platinum.

It may also be preferred that
the first noble metal wire is made of a binary platinum alloy consisting of platinum and rhodium,
the second noble metal wire is made of a ternary platinum alloy consisting of platinum, rhodium and palladium, and
the third noble metal wire is made of a ternary palladium alloy consisting of palladium, platinum and rhodium.

In particular, the first noble metal wire may consist of a PtRh(2-10) alloy, the second noble metal wire of a PtRh(1-16)Pd(1-20) alloy, and the third noble metal wire of a PdPt(3-30)Rh(1-5) alloy.

In further preferred embodiments of the catalyst system according to the invention,
the first noble metal wire is made of a ternary platinum alloy consisting of platinum, palladium and rhodium,
the second noble metal wire is made of a ternary platinum alloy consisting of platinum, rhodium and palladium, and
the third noble metal wire is made of a binary palladium alloy consisting of palladium and nickel, tungsten, platinum and gold.

In particular, the first noble metal wire may consist of a PtPd(1-15)Rh(2-20) alloy, the second noble metal wire of a PtRh(1-16)Pd(1-20) alloy, and the third noble metal wire of a PdNi(3-30) alloy, a PdW(3-30) alloy, a PdPt(3-30) alloy, or a PdAu(3-30) alloy.

In further preferred embodiments of the catalyst system according to the invention,
the first noble metal wire is made of a ternary platinum alloy consisting of platinum, palladium and rhodium,
the second noble metal wire is made of a ternary platinum alloy consisting of platinum, rhodium and palladium, and
the third noble metal wire is made of a ternary palladium alloy consisting of palladium, platinum and rhodium.

In particular, the first noble metal wire may consist of a PtPd(1-15)Rh(2-20) alloy, the second noble metal wire of a PtRh(1-16)Pd(1-20) alloy, and the third noble metal wire of a PdPt(3-30)Rh(1-5) alloy.

The catalyst system may also comprise further components.

The catalyst system may comprise an ignition layer, for example, upstream of the first catalyst gauze group. An ignition layer comprises a noble metal wire which contains only platinum and impurities.

It may also be advantageous that at least the forwardmost catalyst gauze, as seen in the flow direction, contains a noble metal wire made of platinum, which contains no further components besides impurities. This front catalyst gauze may be a catalyst gauze of the first catalyst gauze group.

The catalyst system according to the invention may also comprise at least one further catalyst gauze group consisting of at least one catalyst gauze composed of at least one further noble metal wire.

The at least one further noble metal wire may comprise the same composition as the first, second or third noble metal wire, but the composition may also be different. In such cases too, it is advantageous for the rhodium content of the noble metal wires to decrease or remain constant in the flow direction. In this case, the palladium content of the noble metal wires may remain constant or increase in the flow direction.

The catalyst system according to the invention may contain, for example, at least four catalyst gauze groups, each comprising at least one catalyst gauze composed of at least one noble metal wire. The at least one further catalyst gauze group can be arranged upstream of the first catalyst gauze group or downstream of the third catalyst gauze group. The rhodium content of the noble metal wires decreases in the flow direction or remains the same.

It has proven advantageous for the at least one further catalyst gauze group to be arranged downstream of the third catalyst gauze group. In such cases, it is particularly advantageous if the at least one further noble metal wire comprises a palladium alloy.

In addition to impurities, the palladium alloy of the at least one further noble metal wire particularly preferably consists of 72-97 wt. % palladium, 0-10 wt. % rhodium and 3-28 wt. % of at least one further metal, the at least one further metal being selected from the group consisting of nickel, tungsten, platinum and gold.

The palladium alloy of the at least one further noble metal wire preferably comprises a palladium content in the range of 75-95 wt. %, particularly preferably in the range of 78-90 wt. %.

The palladium alloy of the at least one further noble metal wire preferably contains the at least one further metal in the range of 5-25 wt. %, particularly preferably in the range of 10-22 wt. %.

The palladium alloy of the at least one further noble metal wire may contain any combination from the group consisting of nickel, tungsten, platinum and gold.

The palladium alloy of the at least one further noble metal wire may contain impurities in addition to palladium, nickel, tungsten, platinum or gold and optionally rhodium. The proportion of impurities in total is no more than 1 wt. % of the palladium alloy of the at least one further noble metal wire, preferably no more than 0.5 wt. %.

In preferred embodiments, the palladium alloy of the at least one further noble metal wire is a binary alloy which, in addition to palladium and impurities, contains nickel, tungsten, platinum or gold.

In preferred embodiments of the catalyst system according to the invention,
the first noble metal wire is made of a binary platinum alloy consisting of platinum and rhodium,
the second noble metal wire is made of a ternary platinum alloy consisting of platinum, rhodium and palladium,
the third noble metal wire is made of a binary palladium alloy consisting of palladium and nickel, tungsten, platinum or gold, and
the at least one further noble metal wire comprises a binary palladium alloy consisting of palladium and impurities, nickel, tungsten, platinum or gold.

In particular, the first noble metal wire may consist of a PtRh(2-10) alloy, the second noble metal wire of a PtRh(1-16)Pd(1-20) alloy, the third noble metal wire of a PdNi(3-30) alloy, a PdW(3-30) alloy, a PdPt(3-30) alloy, or a PdAu(3-30) alloy, and the at least one further noble metal wire of a PdNi(3-28) alloy, a PdW(3-28) alloy, a PdPt(3-28) alloy or a PdAu(3-28) alloy.

It may also be preferred that
the first noble metal wire is made of a binary platinum alloy consisting of platinum and rhodium,
the second noble metal wire is made of a ternary platinum alloy consisting of platinum, rhodium and palladium,
the third noble metal wire is made of a ternary palladium alloy consisting of palladium, platinum and rhodium, and
the at least one further noble metal wire comprises a binary palladium alloy consisting of palladium and impurities, nickel, tungsten, platinum or gold.

In particular, the first noble metal wire may consist of a PtRh(2-10) alloy, the second noble metal wire of a PtRh(1-16)Pd(1-20) alloy, the third noble metal wire of a PdPt(3-30)Rh(1-5) alloy, and the at least one further noble metal wire of a PdNi(3-28) alloy, a PdW(3-28) alloy, a PdPt(3-28) alloy, or a PdAu(3-28) alloy.

In further preferred embodiments of the catalyst system according to the invention,
the first noble metal wire is made of a ternary platinum alloy consisting of platinum, palladium and rhodium,
the second noble metal wire is made of a ternary platinum alloy consisting of platinum, rhodium and palladium,
the third noble metal wire is made of a binary palladium alloy consisting of palladium and nickel, tungsten, platinum and gold, and
the at least one further noble metal wire comprises a binary palladium alloy consisting of palladium and impurities, nickel, tungsten, platinum or gold.

In particular, the first noble metal wire may consist of a PtPd(1-15)Rh(2-20) alloy, the second noble metal wire of a PtRh(1-16)Pd(1-20) alloy, the third noble metal wire of a PdNi(3-30) alloy, a PdW(3-30) alloy, a PdPt(3-30) alloy, or a PdAu(3-30) alloy, and the at least one further noble metal wire of a PdNi(3-28) alloy, a PdW(3-28) alloy, a PdPt(3-28) alloy or a PdAu(3-28) alloy.

In further preferred embodiments of the catalyst system according to the invention,
the first noble metal wire is made of a ternary platinum alloy consisting of platinum, palladium and rhodium,
the second noble metal wire is made of a ternary platinum alloy consisting of platinum, rhodium and palladium,
the third noble metal wire is made of a ternary palladium alloy consisting of palladium, platinum and rhodium, and
the at least one further noble metal wire comprises a binary palladium alloy consisting of palladium and impurities, nickel, tungsten, platinum or gold.

In particular, the first noble metal wire may consist of a PtPd(1-15)Rh(2-20) alloy, the second noble metal wire of a PtRh(1-16)Pd(1-20) alloy, the third noble metal wire of a PdPt(3-30)Rh(1-5) alloy, and the at least one further noble metal wire of a PdNi(3-28) alloy, a PdW(3-28) alloy, a PdPt(3-28) alloy, or a PdAu(3-28) alloy.

In a preferred embodiment, the catalyst system according to the invention may comprise at least one separating element between two of the catalyst gauze groups, for example in the form of at least one intermediate gauze. Such intermediate gauzes may be used to counteract a compression of adjacent catalyst gauze groups under pressure load. The intermediate gauze or the intermediate gauzes preferably has/have flexibility that is limited compared to the catalyst gauzes of the catalyst gauze groups.

Suitable separating elements are, for example, elements or gauzes made of a heat-resistant steel, typically a FeCrAl alloy such as Megapyr or Kanthal, stainless steel or of heat-resistant alloys, such as nickel-chromium alloys. The separating element or elements may also comprise a catalytically active coating comprising at least one noble metal.

It has proven advantageous if a separating element, in particular an intermediate gauze, is arranged between the first catalyst gauze group and the second catalyst gauze group. Intermediate gauzes made of Megapyr or Kanthal have proven to be particularly advantageous.

Separation elements in the form of intermediate gauzes may also be arranged within the catalyst gauze groups.

The catalyst system according to the invention is suitable for the preparation of nitric acid by the Ostwald process. An ammonia-oxygen mixture flows through the catalyst system; in other words, this relates to a catalytic ammonia combustion.

The catalyst system according to the invention is also suitable for preparing hydrocyanic acid by the Andrussow process. An ammonia-methane-oxygen mixture flows through the catalyst system.

The present invention also relates to a method for catalytic oxidation of ammonia, in which a fresh gas containing at least ammonia is conducted through the catalyst system according to the invention. For preferred embodiments of the catalyst system, reference is made to the preceding statements.

The ammonia content of the fresh gas is preferably between 9.5 and 12 vol. %.

The pressure of the fresh gas is preferably between 1 and 14 bar, in particular between 3 and 10 bar. The catalyst gauze temperature is preferably in the range from 500 to 1300° C., preferably in the range from 800 to 1100° C.

Preferably, the fresh gas is conducted through a catalyst system according to the present invention at a throughput in the range from 6 to 60 tN/m²d. The abbreviation “tN/m²d” stands for “tons of nitrogen (from ammonia) per day and a standardized effective cross-sectional area of the catalyst system of one square meter.

The invention is explained below with reference to a drawing and exemplary embodiments and an experiment on catalytic activity.

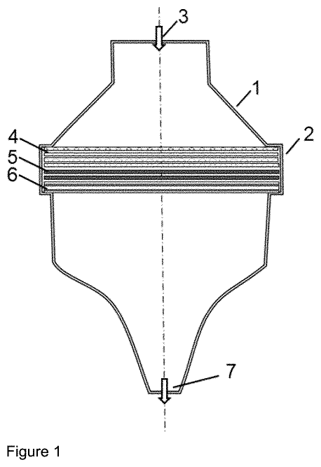

FIG. 1 is a schematic view of a vertically-positioned flow reactor 1 for the heterogeneous catalytic combustion of ammonia. The catalyst system 2 forms the actual reaction zone of the flow reactor 1. The catalyst system 2 comprises a plurality of catalyst gauze groups (4, 5, 6) arranged one behind the other in the flow direction 3 of the fresh gas.

The fresh gas is an ammonia-air mixture comprising a nominal ammonia content of 10.7 vol. %. It is heated to a preheating temperature of 175° C. and introduced from above into the reactor 1 at an elevated pressure of 5 bar. Upon entry into the catalyst system 2, the gas mixture is ignited and a subsequent exothermic combustion reaction takes place. The following main reaction takes place:

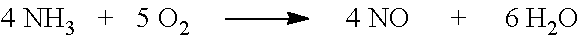

In this case, ammonia (NH₃) is converted to nitrogen monoxide (NO) and water (H₂O). The nitrogen monoxide (NO) formed reacts in the outflowing reaction gas mixture (symbolized by the directional arrow 7 indicating the flow direction of the outflowing reaction gas mixture) with excess oxygen to form nitrogen dioxide (NO₂), which is reacted with water in a downstream absorption system to form nitric acid (HNO₃).

The catalyst gauzes are textile fabrics produced by machine knitting a noble metal wire which has a diameter of typically 76 μm and which is composed of the relevant noble metal alloy. In Tables 1 and 2, exemplary embodiments (E1-E11) of catalyst systems are specified which can be used in a flow reactor 1.

TABLE 1

| | E1 | E2 | E3 | E4 | E5 | E6 |
|---|---|---|---|---|---|---|
| G1 | PtRh5 | PtRh5 | PtRh5 | PtRh5 | PtRh5 | PtRh5 |
| G2 | PtRh5Pd5 | PtRh3.5Pd16 | PtRh2.5Pd17 | PtRh5Pd15 | PtRh4Pd10 | PtRh3Pd12 |
| G3 | PdNi5 | PdW5 | PdPt5 | PdPt5Rh5 | PdPt15 | PdAu5 |

TABLE 2

| | E7 | E8 | E9 | E10 | E11 |
|---|---|---|---|---|---|
| G1 | PtRh5 | PtRh5Pd5 | PtRh5Pd5 | PtPd15Rh5 | PtRh8 |
| G2 | PtRh3.5Pd16 | PtRh4Pd10 | PtRh3Pd12 | PtRh2.5Pd17 | PtRh5Pd5 |
| G3 | PdPt15Rh3 | PdPt20Rh1 | PdPt10Rh1 | PdPt20 | PdPt10Rh5 |

The catalyst systems each comprised 3 catalyst gauze groups with a total of 30 catalyst gauzes; the sequence of the naming G1 to G3 reflects the arrangement in the flow direction of the fresh gas.

In a test reactor according to FIG. 1, the catalyst systems E1-E11 were compared to catalyst systems in which, in each case, only a platinum alloy was used. For this purpose, the selection of alloys was limited to those of the catalyst gauze groups of G2 and G3 or of G1 and G3. In order to ensure a comparable content of catalytically active noble metal in the reactor equipped according to the invention and the comparison reactor, the number of catalyst gauzes was adjusted accordingly.

The test reactors were operated under the following identical test conditions in each case.

| | |
|---|---|
| Pressure: | 5 bar (absolute) |
| Throughput: | 12 tons of nitrogen (from ammonia) per day and |
| | effective cross-sectional area of the catalyst |
| | packing in square meters (abbreviated to 12 tN/m²d) |
| NH₃ proportion: | 10.7% by volume in the fresh gas |
| Preheating temp.: | 175° C. (temperature of NH₃/air mixture), |
| | resulting in a gauze temperature of 890° C. |

At an interval of approximately 12 h, over a period of 4 days, the development of the catalyst efficiency of the catalyst (yield of NO in %) and the amount of nitrous oxide N₂O occurring as an undesired by-product were measured.

The measurement of the catalytic efficiency (i.e., the product yield of NO) has the following sequence:
1. It is ensured that the catalyst system is suitable for the complete conversion of the ammonia used. That means that NH₃ in the product gas is no longer present in a significant amount, which is checked by means of mass spectrometric analysis of the product gas.
2. Simultaneous removal of a sample of NH₃/air upstream of the catalyst packing and a sample from the product gas downstream in respectively independent evacuated pistons. The mass of the gas is determined by weighing.
3. The NH₃/air mixture is absorbed in distilled water and titrated by means of 0.1 N sulfuric acid and methyl red according to color change.
4. The nitrous product gases are absorbed in 3% sodium peroxide solution and titrated by means of 0.1 N sodium hydroxide solution and methyl red according to color change.
5. The catalytic efficiency Eta results from: Eta=100*COₙ/Cₐ, where Cₐ is the mean NH₃ concentration of 7 individual measurements in the fresh gas in percent by weight and Co is the mean NOx concentration of 7 individual measurements, expressed as percent by weight of the NH₃ which has been oxidized to form NOx.
6. Separately, the volumetric proportion of N₂O in the product gas is determined by means of gas chromatography.

In the reactors equipped according to the invention, despite a platinum weight reduced by up to 17% and a rhodium weight reduced by up to 27%, a comparable efficiency was observed over the entire test period, with a comparable proportion of N₂O, in comparison with systems consisting only of the alloys of the catalyst gauze groups G1 and G3. In this technology area, a saving of up to 17% platinum and up to 27% rhodium represents a significant and economically important reduction in these noble metals.

Reactors equipped with a system consisting only of the alloys of the catalyst gauze groups G2 and G3 achieved an ammonia oxidation efficiency reduced by approximately 1% in comparison with catalyst systems according to the invention and are therefore to be classified as uneconomical despite considerable savings in platinum and rhodium.

1. A catalyst system for a flow reactor, comprising at least three catalyst gauze groups arranged one behind the other in the flow direction,
each catalyst gauze group being formed from at least one catalyst gauze composed of at least one noble metal wire in each case, and
the first catalyst gauze group comprising at least one catalyst gauze composed of at least one first noble metal wire made of a platinum alloy, the platinum alloy of the first noble metal wire consisting of, in addition to impurities, 80-98 wt. % platinum, 2-20 wt. % rhodium, and 0-15 wt. % palladium,
the second catalyst gauze group comprising at least one catalyst gauze composed of at least one second noble metal wire made of a platinum alloy, the platinum alloy of the second noble metal wire consisting of, in addition to impurities, 75-98 wt. % platinum, 1-16 wt. % rhodium, and 1-20 wt. % palladium, and
the third catalyst gauze group comprising at least one catalyst gauze composed of at least one third noble metal wire made of a palladium alloy, the palladium alloy of the third noble metal wire consisting of, in addition to impurities, 70-97 wt. % palladium, 0-10 wt. % rhodium, and 3-30 wt. % of at least one further metal, the at least one further metal being selected from the group consisting of nickel, tungsten, platinum and gold,
wherein
the rhodium content of the noble metal wires of the catalyst gauze groups decreases or remains constant in the flow direction and
the palladium content of the noble metal wires of the catalyst gauze groups increases in the flow direction.

2. The catalyst system according to claim 1, wherein the catalyst gauzes are woven, knitted or braided independently of one another.

3. The catalyst system according to claim 1, wherein at least one of the catalyst gauzes comprises a three-dimensional structure.

4. The catalyst system according to claim 3, wherein at least one of the catalyst gauzes is corrugated.

5. The catalyst system according to claim 1, wherein the noble metal wires have a diameter of 40-250 μm.

6. The catalyst system according to claim 1, wherein the proportion of the impurities in the alloys of the noble metal wires is, in each case, no more than 1 wt. %.

7. The catalyst system according to claim 1, wherein the platinum alloy of the first noble metal wire contains no more than 10 wt. % palladium.

8. The catalyst system according to claim 1, wherein the palladium content of the third noble metal wire is above the palladium content of the second noble metal wire by at least 2 weight percentage points.

9. The catalyst system according to claim 1, wherein the rhodium content of the third noble metal wire is below the rhodium content of the second noble metal wire by at least 2 weight percentage points.

10. The catalyst system according to claim 1, wherein the third noble metal wire comprises a ternary palladium alloy which consists of, in addition to impurities, palladium, platinum and rhodium, or comprises a binary palladium alloy which consists of, in addition to impurities, palladium and nickel, tungsten, platinum or gold.

11. The catalyst system according to claim 1, wherein the third noble metal wire is rhodium-free.

12. The catalyst system according to claim 1, wherein the catalyst system comprises at least one further catalyst gauze group composed of at least one catalyst gauze composed of at least one further noble metal wire.

13. The catalyst system according to claim 1, wherein the catalyst system comprises at least one separating element between two of the catalyst gauze groups.

14. A method for catalytic oxidation of ammonia, in which a fresh gas containing at least ammonia is conducted through a catalyst system according to claim 1.

15. The catalyst system according to claim 2, wherein at least one of the catalyst gauzes comprises a three-dimensional structure.
